(19) United States
(12) Patent Application Publication
(10) Pub. No.: US 2022/0198475 A1
(43) Pub. Date: Jun. 23, 2022

(54) SYSTEM FOR GENERATING USER-SPECIFIC RECOMMENDATIONS, SHOPPING LISTS, AND INSTRUCTIONS

(71) Applicant: Green As It Gets, Inc., Bakersfield, CA (US)

(72) Inventors: Jere White, Bakersfield, CA (US); Rita White, Bakersfield, CA (US); Eric White, Bakersfield, CA (US)

(73) Assignee: Green As It Gets, Inc., Bakersfield, CA (US)

(21) Appl. No.: 17/131,152

(22) Filed: Dec. 22, 2020

(51) Int. Cl. G06Q 30/02; G06Q 30/06; G06Q 10/08

(52) U.S. Cl. CPC G06Q 30/02; G06Q 30/0633; G06Q 10/087; G06Q 30/0641; G06Q 30/0631

(57) ABSTRACT

A system for recommending products and providing instructions for projects is disclosed, the system comprising a product database to store a plurality of product information and a project database to store a plurality of project information. The project information includes a plurality of steps and a plurality of products to complete the project. A user interface module displays the plurality of steps and the plurality of products on a display of a computing device. A recommendation engine recommends at least one of the plurality of products and an amount for each of the plurality of products to complete at least one of the plurality of projects. The recommendation engine is in operable communication with the product database and the project database to recommend the at least one product and the at least one project to the user based on an inventory of a store.

### CROSS-REFERENCE TO RELATED APPLICATIONS

The present application claims priority to U.S. Provisional Patent Application 62/948,089 filed on Dec. 30, 2019, entitled “Method of creating user-specific project recommendations, shopping lists, and project instructions” the entire disclosure of which is incorporated by reference herein.

### TECHNICAL FIELD

The embodiments generally relate to computerized systems for storing product information and, more particularly, relate to computerized systems for storing inventory related to the agricultural arts and recommendations for the planting, maintenance, and cultivation thereof.

### BACKGROUND

Growing plants is a popular pastime for many to grow food or to decorate a landscape. The various processes of planting and appropriately maintaining plants can be difficult for many due to the natural complexity of caring for the plants in various climates and times of year, leading to frustration when efforts to grow the plants are unsuccessful. To aid in the planting and maintenance processes, many plants or plant providers provide a generic guide. The guide may include planting instructions, maintenance instructions, light requirements, optimal temperature ranges, etc.; however, this information is often over-generalized and includes few specific details, leaving beginner or novice gardeners confused.

Often, gardeners may seek the expertise of employees at a gardening store or gardening department within a home improvement store. Certainly, while many employees may able to provide useful knowledge to the gardener, this could be difficult for new or seasonal employees who do not have access to the same level of experience or knowledge base. Further, complex calculations for determining proper amounts of fertilizer, growing medium, nutrients, etc. may be difficult for such employees to quickly determine and accurately recommend. Product labels often do not contain this specific information, forcing the gardener to search through books, internet forums, and the like to determine best practices for each plant they are purchasing.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a system for recommending products and providing instructions for projects, the system comprising a product database to store a plurality of product information and a project database to store a plurality of project information. The project information includes a plurality of steps and a plurality of products to complete the project. A user interface module displays the plurality of steps and the plurality of products on a display of a computing device. A recommendation engine recommends at least one of the plurality of products and an amount for each of the plurality of products to complete at least one of the plurality of projects. The recommendation engine is in operable communication with the product database and the project database to recommend the at least one product and the at least one project to the user based on an inventory of a store.

The system may be utilized by homeowners when embarking on and completing various do-it-yourself projects, such as gardening, landscaping, etc., by professional tradesmen who may need assistance calculating a shopping list or when considering on an amount to bid on a project, and by retailers to make dynamic product recommendations. The system allows a store to provide accurate and up-to-date information regarding projects and the products offered within the store to complete the projects. The information may be altered based on changing seasons, weather, or other store-specific knowledge and variables to provide the end-user with information relevant to their unique location.

The system may be operable via the users computing device and/or via an in-store kiosk which is operable to perform the various functionalities of the system using the components described herein. The in-store kiosk may include a printer to print a shopping list, product information, etc. which the user may utilize in the store to facilitate their purchase. The kiosk may also include a scanner to scan a barcode, QR code or similar implement associated with user and/or product information.

In one aspect, the system may include a plant diagnostic system to assess a deficiency with one or more plants which the user has purchased. The plant diagnostic system may then utilize the diagnostic database to suggest common problems with the plants which the user indicates are having a problem. The recommendation engine may then suggest products to remedy the solution.

In one aspect, the system is operable to suggest, via a recommendation engine, the at least one product offered by the provider to complete the at least one project.

In one aspect, the product database stores a location of the at least one product within the store.

In one aspect, the recommendation engine is in operable communication with a planting rates interface, wherein a provider utilizes the planting rates interface to input amounts of the at least one product needed to complete a project.

In one aspect, a shopping list interface is in operable communication with the planting rates interface, wherein the planting rates interface generates amounts of each of the at least one product and transmits the amounts to the shopping list interface configured to generate a list of the at least one product.

In one aspect, the user selects the at least one product provided on the list to view a plurality of information related to the at least one product.

In one aspect, the plurality of information comprises an image of the at least one product.

In one aspect, a provider list interface permits the provider to input store information including a location corresponding to the provider.

In one aspect, a project interface is in operable communication with the project database, wherein the project interface permits the provider to input a plurality of project steps.

In one aspect, the project interface generates a planting guide comprising the plurality of project steps to complete the project, and wherein the planting guide is provided on the display of the computing device.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of the application system, according to some embodiments;

FIG. 3 illustrates a block diagram of the recommendation engine, according to some embodiments;

FIG. 4 illustrates a block diagram of the project generator, according to some embodiments;

FIG. 5 illustrates a block diagram of the provider system, according to some embodiments;

FIG. 6 illustrates a screenshot of the provider management interface, according to some embodiments;

FIG. 7 illustrates a screenshot of the inventory selection interface, according to some embodiments;

FIG. 8 illustrates a screenshot of the projects interface, according to some embodiments;

FIG. 9 illustrates a screenshot of the product setup interface, according to some embodiments;

FIG. 10 illustrates a screenshot of the planning rates interface, according to some embodiments;

FIG. 11 illustrates a screenshot of the planting guides interface, according to some embodiments;

FIG. 12 illustrates a screenshot of the planting guide builder interface, according to some embodiments;

FIG. 13 illustrates a screenshot of the provider locations interface, according to some embodiments;

FIG. 14 illustrates a screenshot of the shopping list interface, according to some embodiments;

FIG. 15 illustrates a block diagram of the database infrastructure, according to some embodiments; and

FIG. 16 illustrates a screenshot of the planting guide, according to some embodiments;

FIG. 17 illustrates a block diagram of the in-store kiosk system, according to some embodiments;

FIG. 18 illustrates a block diagram of the inventory management system, according to some embodiments; and

FIG. 19 illustrates a block diagram of the plant diagnostic system, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a system for generating recommendations for products at a store depending on user input for a desired product, project, or other user parameter. The system may generate a shopping list based off one or more products input by the user, the project, or other parameter. In such, the user may utilize the system to input a product and/or project and receive instructions for completing tasks associated with the product and/or project. For example, the user may input a plant they would like to purchase at a particular store. The system will then generate recommended products that are associated with the plant, such as soil, nutrients, tools, or other products at the store location. The system may also generate instructions for completing a task associated with the project, such as generating a shopping list with specific sizes and quantities of product(s) to purchase and generating instructions for the process of using each product during the completion of the task.

The system may be utilized by homeowners when embarking on and completing various do-it-yourself projects, such as gardening, landscaping, etc., by professional tradesmen who may need assistance calculating a shopping list or when considering on an amount to bid on a project, and by retailers to make dynamic product recommendations.

The embodiments provided herein utilize the exemplary industry of gardening/landscaping. However, one skilled in the arts will readily understand that the embodiments may be applied to various industries including plumbing, painting, construction, automotive, or similar industries. The embodiments are especially useful for the do-it-yourself user.

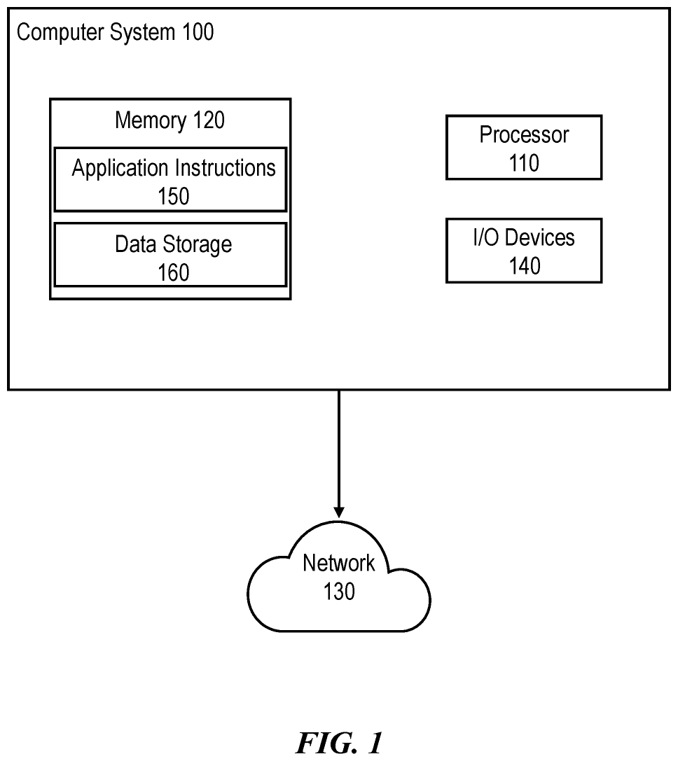

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The memory may be utilized to store product inventory, product information, project recommendations and steps thereof, seasonal weather information, store information, employee information, user preferences, and similar information.

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

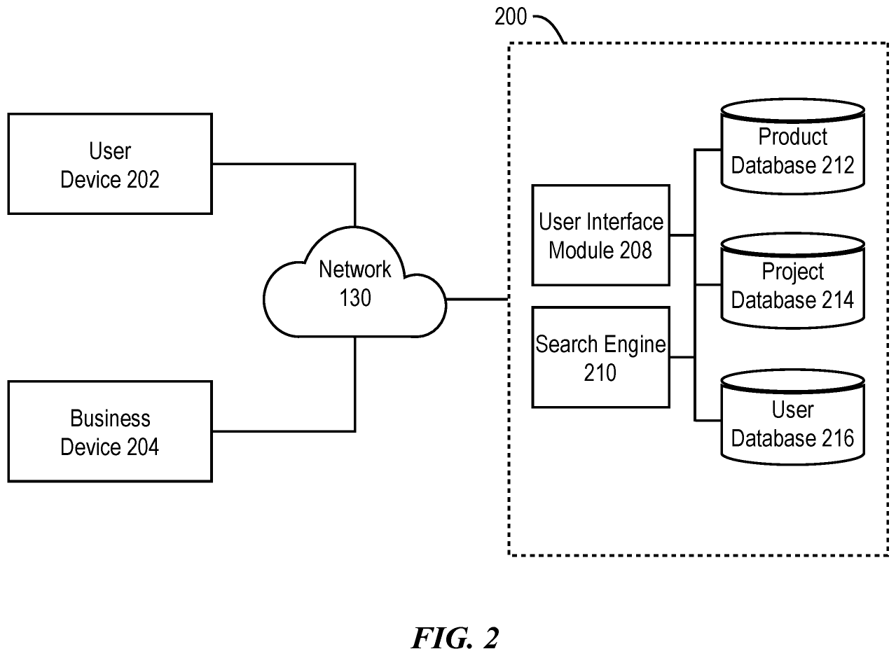

FIG. 2 illustrates a block diagram of the application system 200 in operable communication with a user device 202 and a provider device 204 via a network, wherein the provider device is used by a store or network of stores and employees thereof. The application system 200 includes a user interface module 208 and a search engine 210 in operable communication with a product database 212, project database 214, and user database 216. The product database 212 stores product inventory for within a single store location or in a plurality of store locations. The product database 212 may also contain product information including product name, type, best practices for using the product, recommended projects associated with one or more products, etc. The project database 214 stores project instructions including the steps required to complete the project and other information associated with a project, which the user may engage using products purchased at a store. The user database 216 stores user information such as user preferences, user purchases, user projects, and the like. In such, the system may utilize the information stored in each database to generate suggestions and display the suggestions to the user. The user interface module 208 displays information provided by the application system 200 to the user on the user device 202.

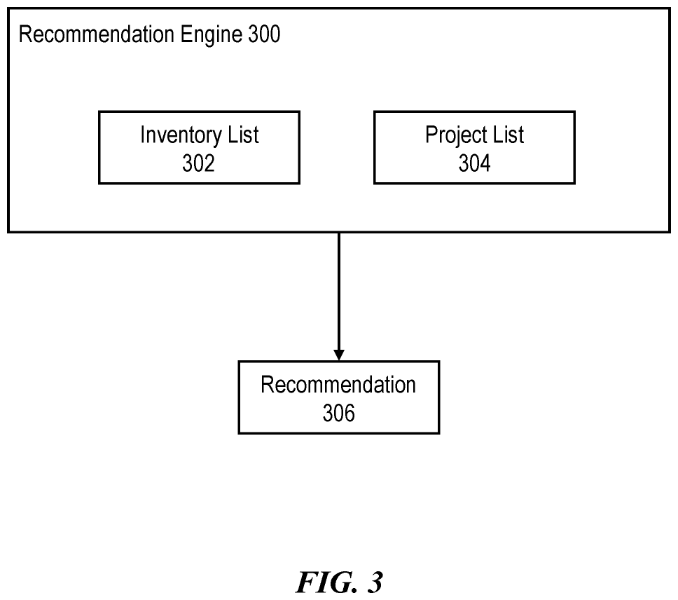

FIG. 3 illustrates a block diagram of the recommendation engine 300 which receives user input and generates a recommendation 306 based off the user input. For example, the user may select a gardening project. The recommendation engine 300 may receive information from an inventory 302 containing a list of products available, and a project list 304 comprising projects which use various products in the inventory list 302. The system may then output a recommendation 306 comprising one or more products, projects, and instructions associated thereto. The recommendation engine 300 may consider the plant type, plant size, weather, seasonal variability, user skill level and similar parameters to suggest a suitable product and/or project.

In some embodiments, the inventory list may allow the user to select one or more products and engage with additional information related to the product such as product features, product benefits, recommended uses of the product, alternative uses of the product, similar products, etc. In such, the system may correlate a plurality of products which are related or complimentary to one another.

In some embodiments, the recommendation engine 300 may suggest consumables to buy in bulk based on store inventory, store sales, and promotions to simplify the maintenance of the plant and save the consumer money.

The recommendation engine 300 allows the system to make dynamic recommendations 306 for products depending on current weather, season, availability of products, user interests, etc. In such, the system acts as an industry expert by receiving input from the user for products and/or projects they would like to complete, and it provides recommendations 306 and instructions for completing the project.

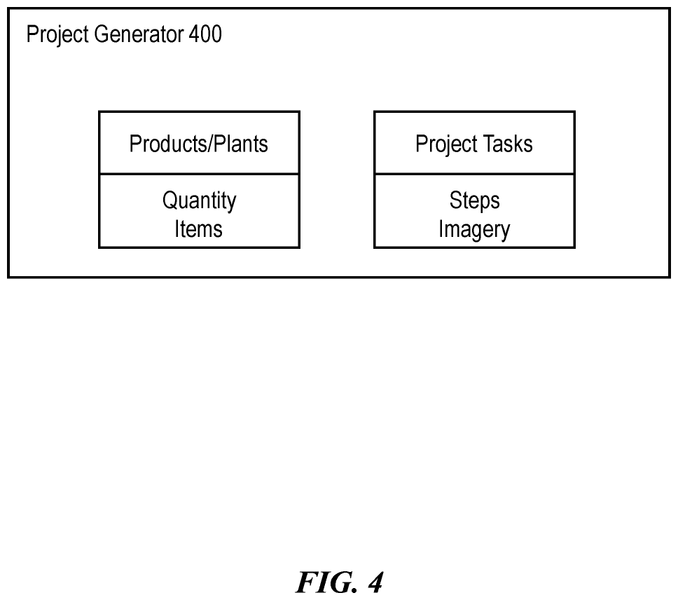

FIG. 4 illustrates a block diagram of the project generator 400 wherein the system may output instructions for completing a project. For example, the user may select one or more plants that they would like to plant at their home. The project generator 400 may then determine that the user needs a specific amount of soil for planting the one or more plants. The project generator 400 may then generate a list of tasks including generating a shopping list and amount of materials needed, suggested tools, and steps for executing the planting process.

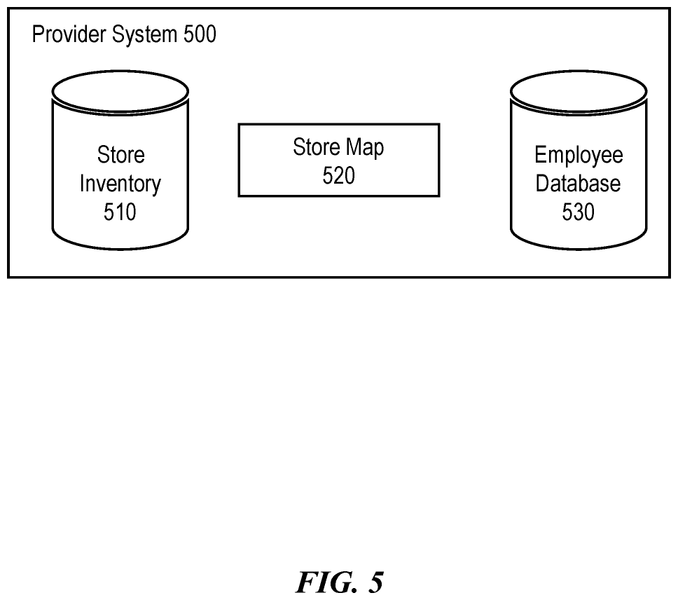

FIG. 5 illustrates a block diagram of the provider system 500 comprising a store inventory database 510, a store map 520, and an employee database 530. The store inventory database 510 retains store inventory information in real-time inventory levels and correlates the inventory to a store map 520. The employee database 530 may retain information pertaining to various employees at the store, such as an employee's experience or training in relation to particular projects or products, or employee input relating to projects and products or associations therebetween. In such, an employee or consumer may use the store map to locate products within the store or plan a shopping experience throughout the store.

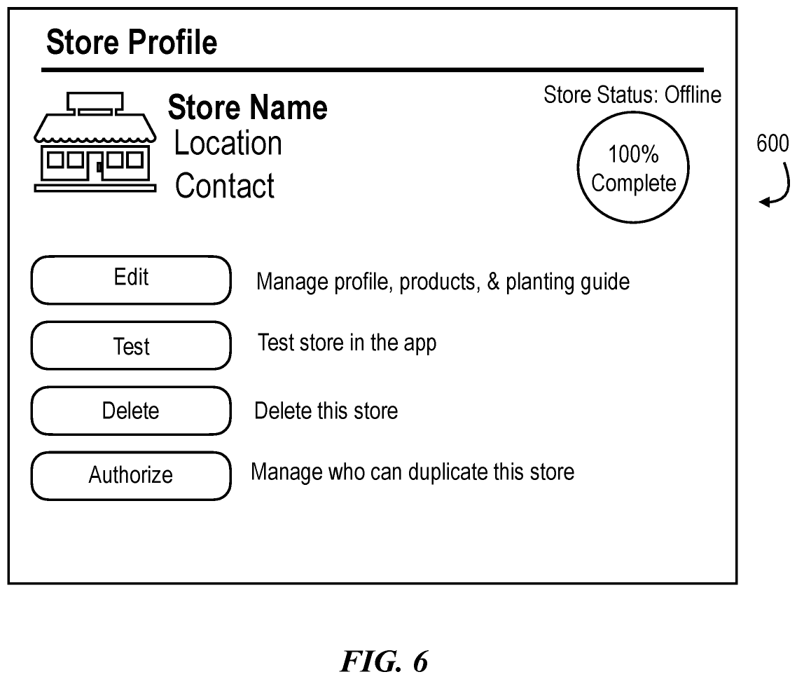

FIG. 6 illustrates a screenshot of the provider management interface 600 wherein the provider (e.g., a home improvement store, gardening shop, etc.) can input provider profile information (e.g., name of the store, locations), product information, and project guides (e.g., planting guides) which may be created by the provider or selected from a list of pre-generated guides. The provider management interface 600 may provide a means for inputting user permissions, and other administrative functionalities.

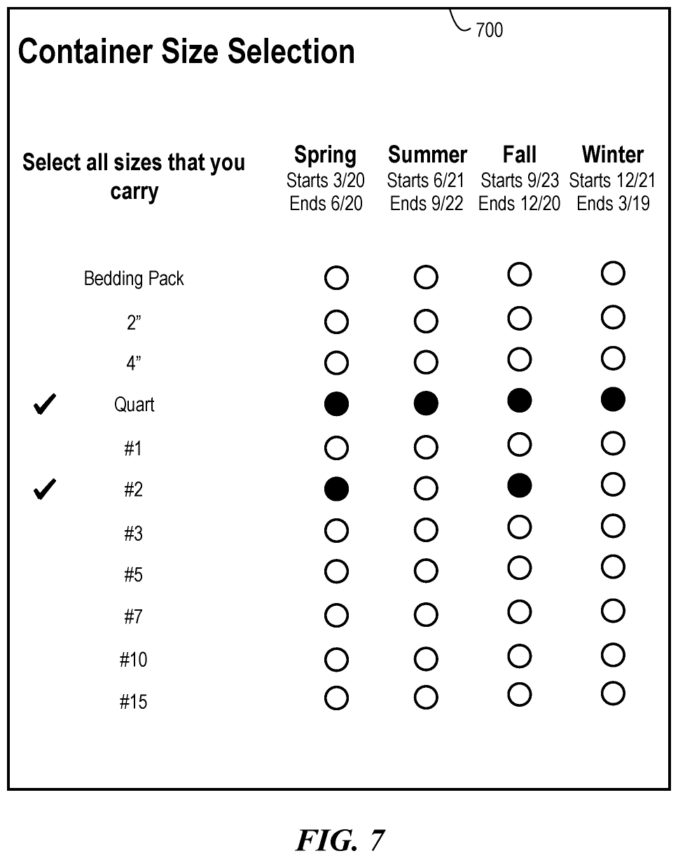

FIG. 7 illustrates an inventory selection interface 700 wherein the provider will select products which they have in their inventory. For example, the user may select a plurality of plant container sizes which the store keeps stocked throughout the year. The provider user may select options for seasonal variability in the inventory, such as by selecting that specific sizes or styles are only available during the spring and summer seasons. The inventory selection interface 700 receives information from the providers point-of-sale (POS) system (or similar inventory management system) and displays information received therefrom. In such, the inventory selection interface 700 provides up-to-date inventory levels, prices, etc. and other information contained in the providers inventory management system.

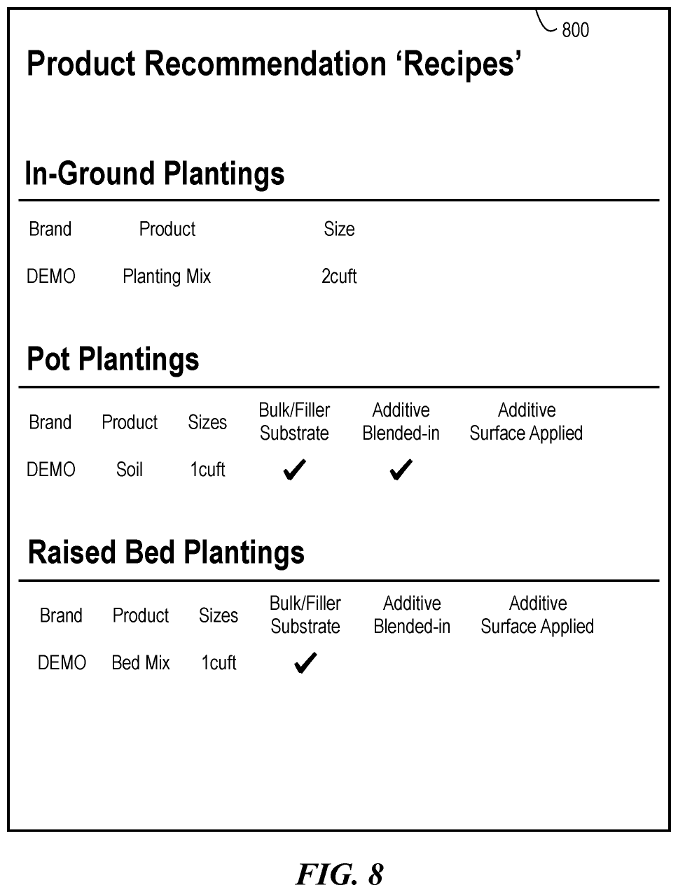

FIG. 8 illustrates a projects interface 800 wherein the provider can input a plurality of project instructions related to various projects. The projects may be separated by project types, such as in-ground plantings, pot planting, raised bed plantings, etc. This allows the system to receive instructions for projects while using the instructions to generate a list of recommendations based on products associated with each set of instructions. Each project may have a correlated list of products (including product amounts) needed to complete the project.

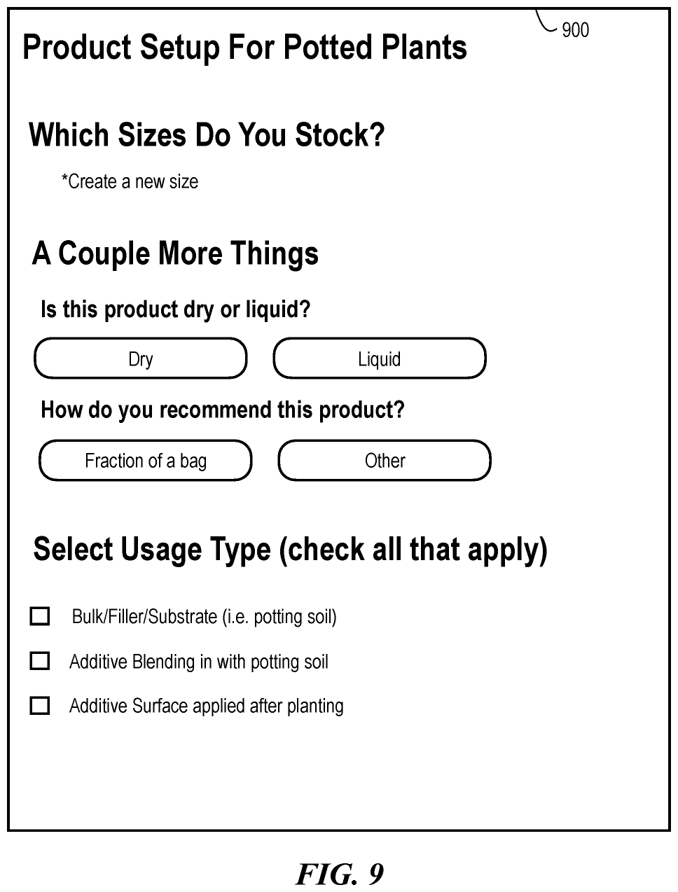

FIG. 9 illustrates the product setup interface 900 wherein the provider can select a product which they would like to upload to the system. The product setup interface 900 may provide inputs for product sizes, product type (e.g., liquid, dry, etc.), how the product is recommended to be purchased (e.g., by the bag, in bulk, etc.), and selection of a usage type (e.g., bulk, additive, etc.). This information will be used to calculate how much of each product the consumer will need for a particular project. Further, the system may transform quantities to various other units (such as standard measurements of cups, ounces, etc.).

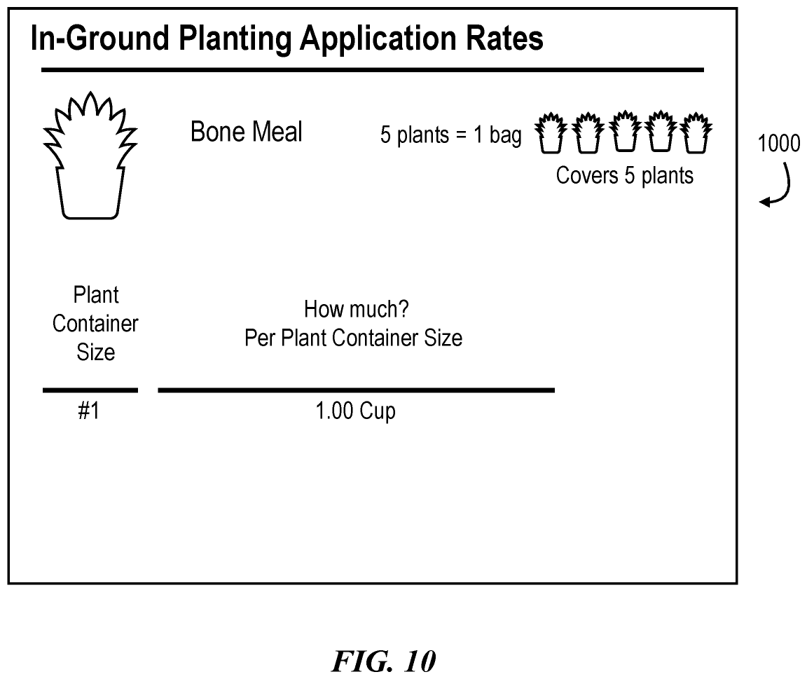

FIG. 10 illustrates the planting rates interface 1000 wherein the user inputs an amount needed for various applications of the product. The user will select a product and indicate which container size they are using a for a particular plant. The user then inputs a quantity that is needed for each container size. The user may also input a unit for the quantity (e.g., cups) to simplify the measuring process for the end user. The system then generates a schematic showing the amount of plants which can be grown from the product (such as showing that one bag of product is suitable for 5 plants in a specific container size).

In some embodiments, the user may input products by scanning a code (e.g., a barcode, QR code, RFID tag or the like) using a barcode scanner, in-store kiosk, using their mobile device, or other suitable device to identify the product and transmit the product information to the system.

In some embodiments, the system may consult known values and usage rates for products. In such, the system may automatically determine amounts of product needed for a particular application without the need for the user to manually input recommendations for each product. In another embodiments, the user may customize rates based on a plurality of factors including personal experience, personal expertise, weather, soil conditions, etc.

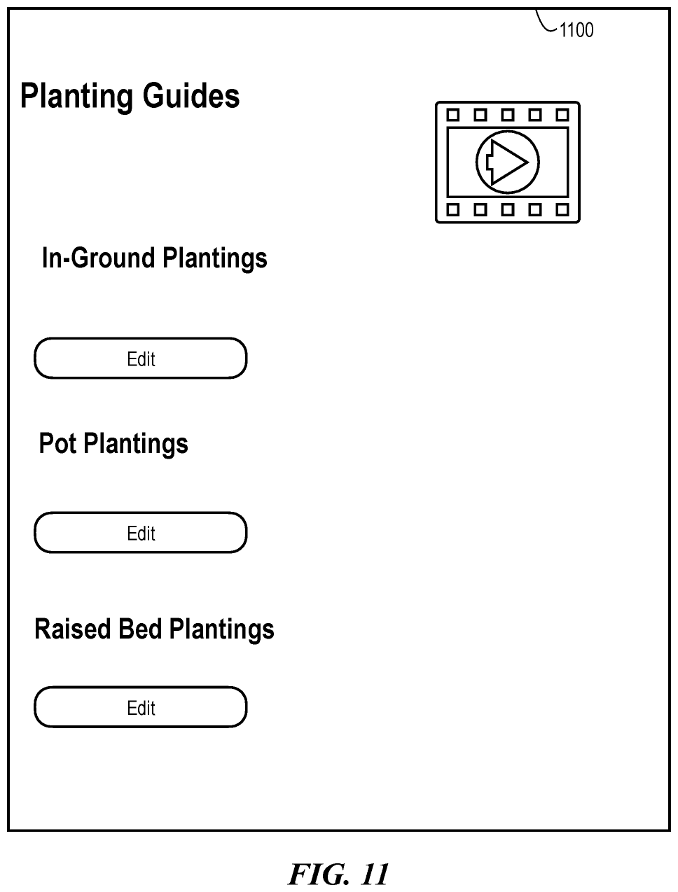

FIG. 11 illustrates the planting guides interface 1100 wherein the user can input planting guide information for various project types such as in ground planting, pot planting, and raised bed planting. The user is able to customize step-by-step project steps with customized graphics and visual aids for each step. Planting guides may be transmitted to the user using various communication systems. The planting guide may be provided via email or shown via the users computing device. The planting guide may be provided as a downloadable file, or as a dynamic interactive file.

In some embodiments, media may be uploaded through the planting guides interface 1100, such as instructional imagery, videos, audio files, and the like. In such, the consumer may access the instructional media to gain instructional knowledge before or during the project.

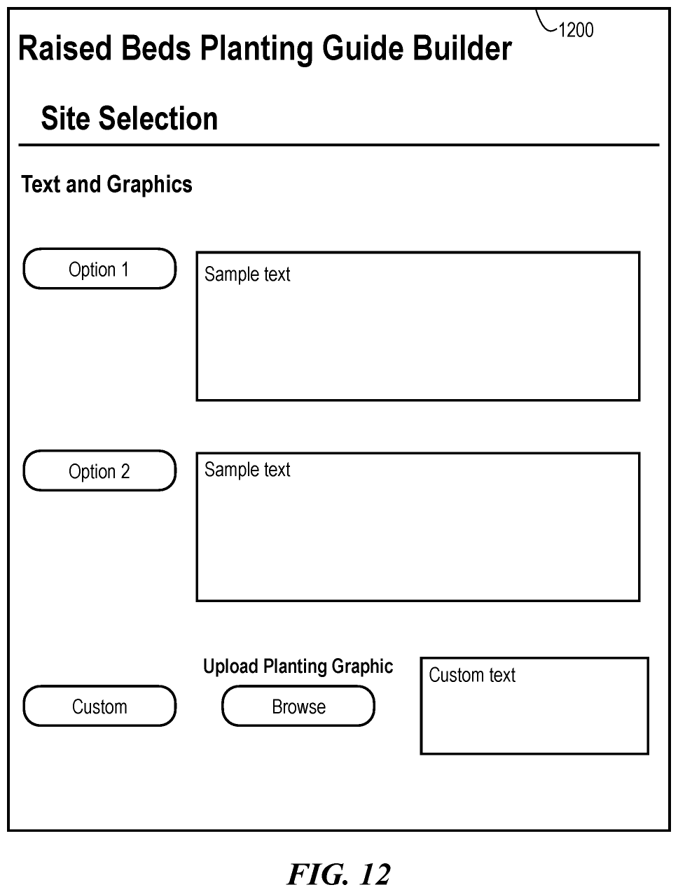

FIG. 12 illustrates the planting guide builder interface 1200 wherein the provider can input text containing instructions for the project. The user may also select to include various forms of media (e.g., video, imagery, etc.) to be included in the guide. In some embodiments, the system may automatically fill various fields including the amounts required for products, containers, and the like.

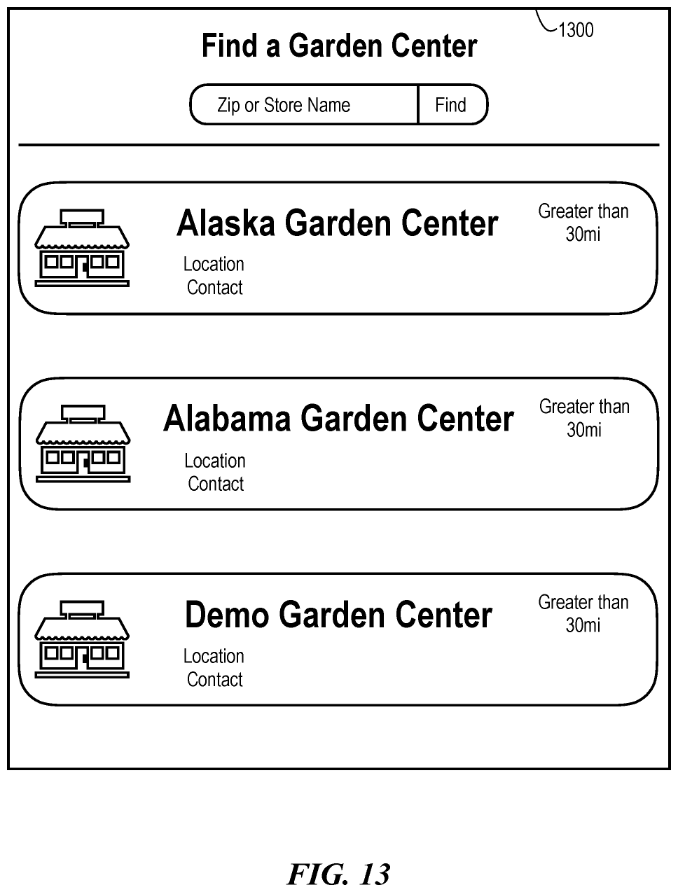

FIG. 13 illustrates a screenshot of the provider locations interface 1300 wherein the user can input a location in which they would like to search for a particular store. The system will then search the location and display a listing of results. Each result may include general business information including the name, location, and contact information of the business. The user may be permitted to select the business to access further information such as product information, planting guides, etc. Further, the system geolocate the business in reference to the location of the customer, or preferred search location.

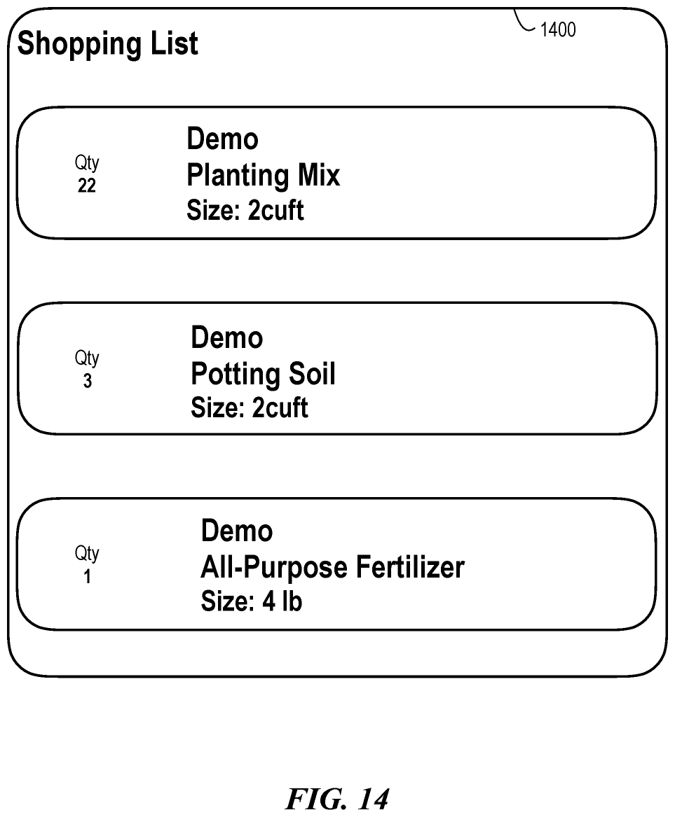

FIG. 14 illustrates a shopping list interface 1400, which is generated by the system to provide a convenient display of the products (and sizes and quantities thereof) needed to complete a project. The shopping list interface 1400 may include a plurality of products and amounts associated with each product. This generates a shopping list, which is provided on the users computing device. The shopping list may be automatically updated while the user is shopping in the store. For example, the user may check-off products that are in their cart, or items which they have already purchased. The shopping list may also include an image of the product to facilitate the user finding the correct product on the shelf.

In some embodiments, the shopping list interface may be provided on an in-store kiosk. The in-store kiosk may permit the user to interact with the various features of the system described herein. Further, the in-store kiosk may comprise a printer to print a hard-copy of a shopping list, product description(s), directions to the product(s) within the store, and other information provided by the system.

In some embodiments, the user may select a product on the shopping list to view the products location in the store. For example, the user may select a soil additive to view the soil additives location on a particular isle.

The shopping list may be configured to simplify the shopping experience, and thus may advantageously provide part numbers, product descriptions, manufacturer information, quantities needed, price, assembly references and the like. It should be appreciated, however, that all, few or none of these features may be provided for a particular project. Further, additional items of interest or assistance to the consumer may also be provided. The shopping list enable the ready purchase of the necessary materials. In this manner repetitive purchase are minimized and consumer happiness enhanced.

The system may facilitate the purchase of goods provided on the shopping list. A purchase can occur in accordance with various aspects of the present embodiments by way of an e-commerce purchase. Once the system provides the shopping list comprising the necessary materials and tools and the appropriate location where such tools and materials can be obtained, the user may simply enter into a transaction with the store, such as via the Internet, to facilitate the purchase. Likewise, the purchase may be executed in a non-electronic manner. For example, the purchaser may travel to the location and purchase at that location in a conventional manner the necessary materials and tools. In such, the system reduces the need for repetitive purchases of the materials and/or tools needed to complete a project as described hereinabove.

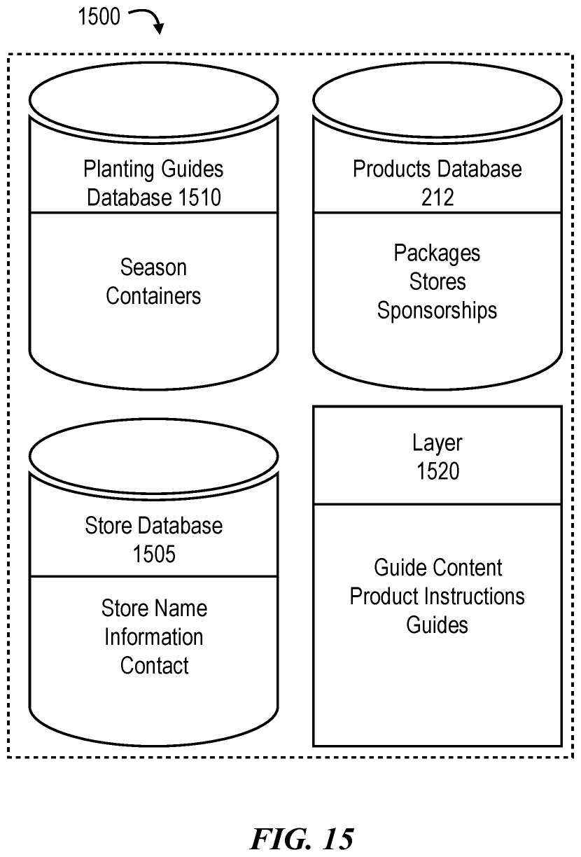

FIG. 15 illustrates a block diagram of the database infrastructure 1500 including a store database 1505 having store information corresponding to each individual store utilized by the system. The planting guides database 1510 includes season information, container information, and information pertaining to each. Seasonal and product information may be input by each store. A products database 212 includes product information, product packaging information (including packaging imagery), sponsorships, and similar product-related information. Layer 1520 includes planting guide content, instructions for the planting guide and products thereof, and similar information.

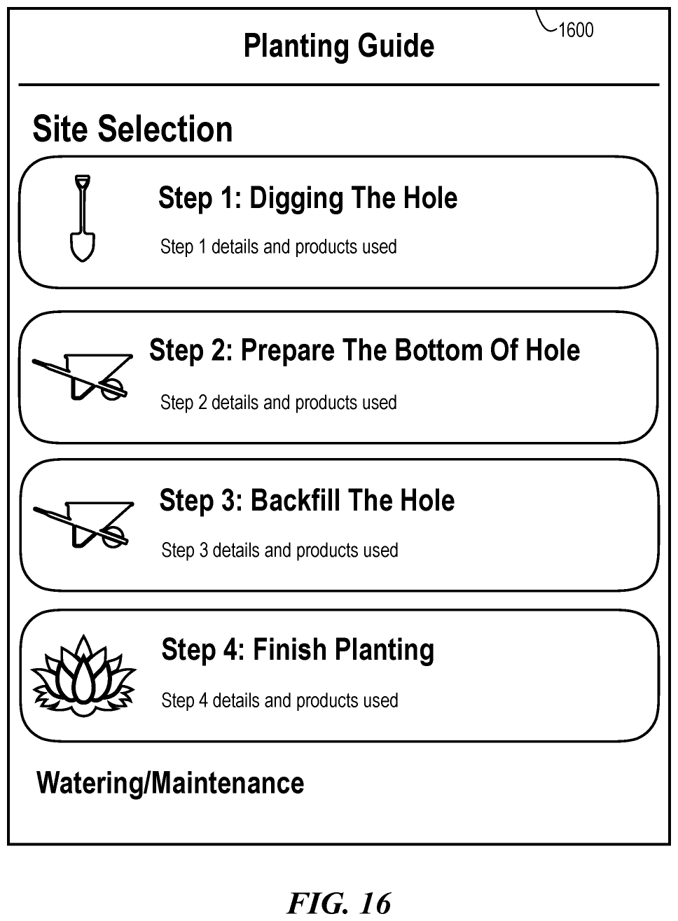

FIG. 16 illustrates an exemplary planting guide 1600, which is provided to the end-user (e.g., the gardener). The planting guide includes a plurality of steps for completing the project. In one example, and in step one, the user determines a suitable planting location and digs the hole. The user is instructed to dig the hole twice as wide and twice as deep as the rootball of the plant. In step two, the user prepares the bottom of the hole by placing an amount of one or more products into the hole, and the user tamps down the product with their foot or other tool. In step three, the user backfills the hole, and in step four, the user finishes the planting process with one or more amendments. One or more visual aids may be provided to help the user complete the steps and provide the highest likelihood of success when planting the plants (i.e., completing the project).

The planting guide includes products on the user's shopping list. The products and information thereof in provided in the correct step of the process in which they will be utilized. The product information will include step-by-step instructions for how to use each product including amounts and other useful advice. In some embodiments, this product information may be generated by the provider (each specific store location).

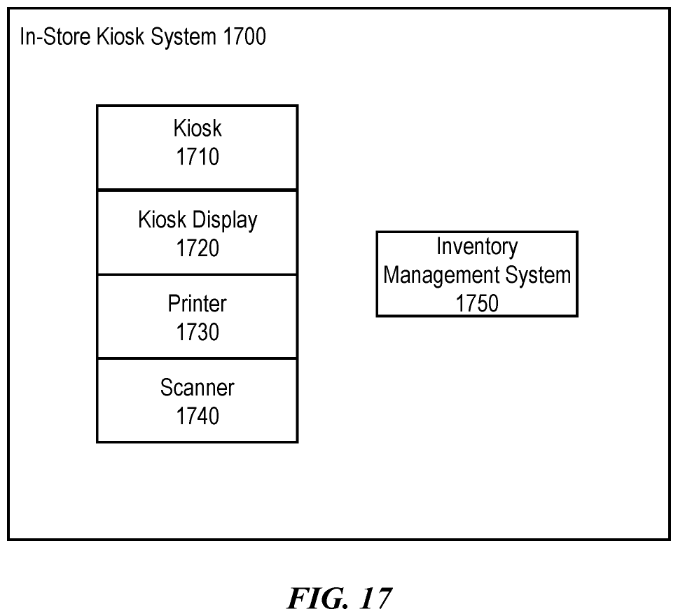

FIG. 17 illustrates the in-store kiosk system 1700 comprising a kiosk 1710 positioned within a store location. The kiosk 1700 includes a computer system in operable communication with a kiosk display 1720 to allow the user to interact with the various functionalities of the system. A printer 1730 may allow the user to print a hard-copy document which may include a shopping list, product information, directions to the product within the store, and other information which may be useful to the user while shopping for plants and related products and/or planting and maintaining the plant. A scanner 1740 may permit the user to scan a barcode, quick-response (QR) code, or radio frequency identification (RFID) tag on their smart device or similar computing device. The kiosk 1700 is in wireless or wired communication with the stores inventory management system 1750.

In some embodiments, the scanner may scan the user's smart device, membership card, etc. which corresponds to a user account. The user account may store previous purchases made by the user, previous interactions the user has made with the system, payment information, and the like.

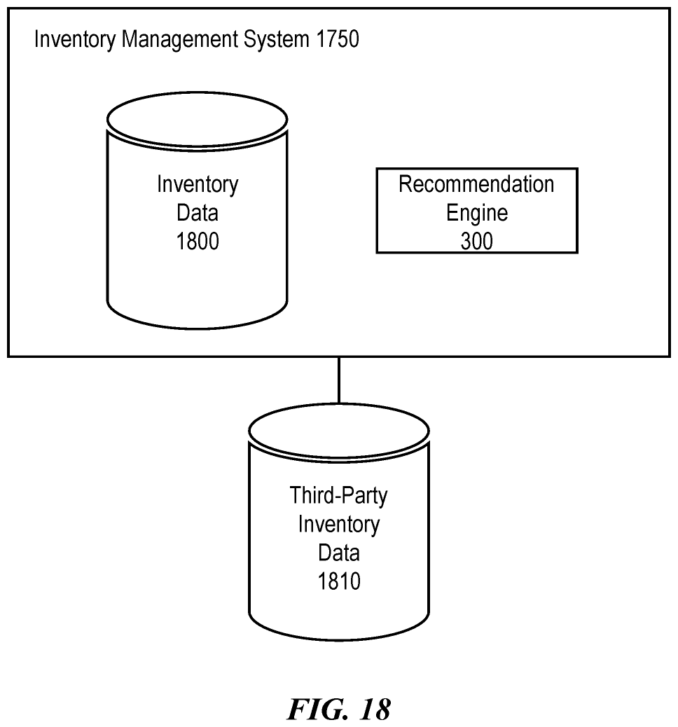

FIG. 18 illustrates a block diagram of the inventory management system 1750 wherein product inventory, prices, promotions, and other information commonly stored in an inventory management system is stored. The inventory management system 1750 is in operable communication with the recommendation engine 300 such that the recommendation engine 300 receives up-to-date inventory data 1800 such that in-stock products may be recommended to the user. The inventory management system 1750 may be in communication with third-party inventory databases 1810 to allow the user to source products which may be out of stock at their location.

The design aspects of the present embodiments are advantageously provided to facilitate ease of use. For example, as previously noted, the customer accesses a website to gain access to the materials needed and information thereof. This access, preferably, enables the formation of an interactive environment in which information can be requested and supplied. For example, the customer can request and provide information, and the website can respond. Similarly, the website systems can request and provide information to the customer.

In some embodiments, the system memory may also store other software instructions , such as web video instructions to facilitate web video-related processes and functions; and/or web shopping instructions to facilitate web shopping-related processes and functions. In some implementations, the media processing instructions are divided into audio processing instructions and video processing instructions to facilitate audio processing-related processes and functions and video processing-related processes and functions, respectively. For example, the system may provide video- and/or audio-based instructions for planting one or more plants which is supplemented by the planting guide. In such, the system provides a multi-media solution for customer relations, promotion of products, and instructional information.

In some embodiments, the system may facilitate communications between the gardener and experts in communication with the system. For example, the gardener may be able to communicate with local store personnel, local gardening experts, or other industry experts in real-time. Alternatively, the system may utilize a machine-learning and/or artificial intelligence engine which receives user input (e.g., a question corresponding to a plant deficiency, health problem, planting instructions, and the like) and generates an output corresponding to the user input.

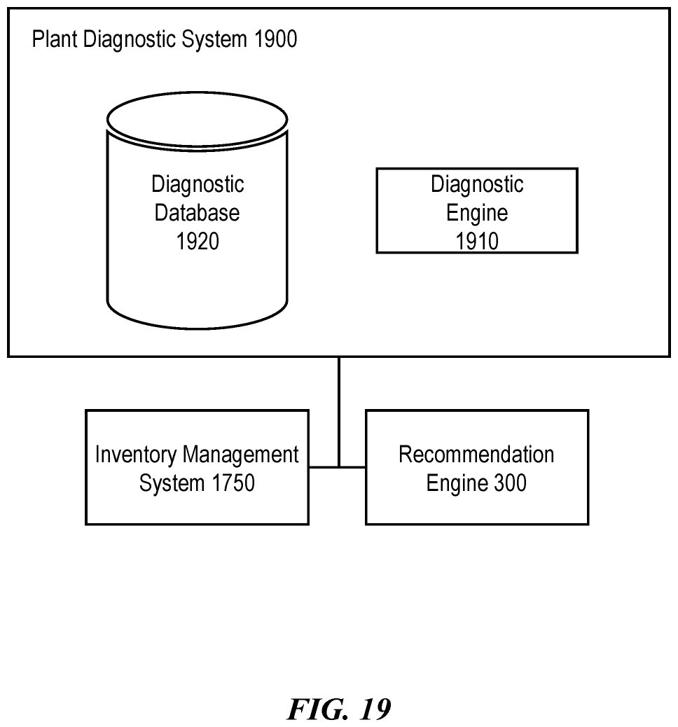

FIG. 19 illustrates a block diagram of the plant diagnostic system 1900 which may aid the user in diagnosing plant diseases, nutrient deficiencies, malnutrition, and the like. In such, the user may input signs and symptoms expressed in the appearance of the plant. A diagnostic engine 1910 receives the user input and determines a cause for the plant to be unhealthy. The recommendation engine 300 may then receive information from the diagnostic engine and suggest products which will remedy the problem. In one example, the system may ask the user if specific plants they have purchased are healthy. If one or more are not, the user selects which plants are not healthy. The plant diagnostic system 1900 may be in operable communication with the inventory management system 1750 to display the specific plant, product, etc. which was previously purchased. The plant diagnostic system 1900 may include a diagnostic database 1920 which stores common problems with the plant, supplemented by images which show the appearance of the plant undergoing a particular problem. The recommendation engine 300 may then recommend the products needed to remedy the problem.

In some embodiments, the recommendation engine may suggest seasonal recommendations based on previously purchased plants. For example, specific nutrients, watering protocols, or maintenance instructions may be provided during a specific season to ensure the health of plant. The shopping list and/or planting guide may then be generated based on the recommended products.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for recommending products and providing instructions for projects and maintenance/repair of those projects (ie following up on common insect/disease/other problems the project may experience after planting), the system comprising:
a product database to store a plurality of product information;
a project database to store a plurality of project information, project information including a plurality of steps and a plurality of products to complete the project;
a user interface module to display the plurality of steps and the plurality of products on a display of a computing device; and
a recommendation engine to recommend at least one of the plurality of products and an amount for each of the plurality of products to complete at least one of the plurality of projects, wherein the recommendation engine is in operable communication with the product database and the project database to recommend the at least one product and the at least one project to the user based on an inventory of a store.

2. The system of claim 1, wherein recommendation engine is in operable communication with a planting rates interface, wherein a provider utilizes the planting rates interface to input amounts of the at least one product needed in reference to the plant size and plant type to complete a project.

3. The system of claim 1, further comprising a shopping list interface in operable communication with the planting rates interface, wherein the planting rates interface determines amounts of each of the at least one product needed to complete the project transmits the amounts to the shopping list interface configured to generate a list of the at least one product.

4. The system of claim 3, wherein the user selects the at least one product provided on the list to view a plurality of information related to the at least one product.

5. The system of claim 4, wherein the plurality of information comprises an image of the at least one product.

6. The system of claim 1, further comprising a provider list interface to permit the provider to input store information including a location corresponding to the provider.

7. The system of claim 1, further comprising a project interface in operable communication with the project database, wherein the project interface permits the provider to input a plurality of project steps.

8. The system of claim 7, wherein the project interface generates a planting guide comprising the plurality of project steps and the plurality of product information to complete the project.

9. The system of claim 8, wherein the planting guide is provided on the display of an in-store kiosk, and wherein the kiosk is in operable communication with the recommendation engine to recommend at least one of the one or more products to complete the project.

10. A system for recommending products and providing instructions for projects, the system comprising:
a product database to store a plurality of product information;
a project database to store a plurality of project information, project information including a plurality of steps and a plurality of products to complete the project;
a user interface module to display the plurality of steps and the plurality of products on a display of a computing device;
a recommendation engine to recommend at least one of the plurality of products and an amount for each of the plurality of products to complete at least one of the plurality of projects, wherein the recommendation engine is in operable communication with the product database and the project database to recommend the at least one product and the at least one project to the user based on an inventory of a store; and
a planting guide builder interface configured to permit the provider to select the at least one product and the at least one project to complete a plurality of steps associated with planting the at least one product to generate a planting guide, wherein the planting guide is transmitted to a user device; and
a plant diagnostic system operable to receive a plurality of plant diagnostic information input by a user and suggest one or more products corresponding to the plurality of plant diagnostic information.

11. The system of claim 10, wherein the system is operable to suggest, via the recommendation engine, the at least one product offered by the provider to complete the at least one project.

12. The system of claim 11, wherein product database stores a location of the at least one product within the store.

13. The system of claim 12, wherein recommendation engine is in operable communication with a planting rates interface, wherein a provider utilizes the planting rates interface to input amounts of the at least one product needed to complete a project.

14. The system of claim 13, further comprising a shopping list interface in operable communication with the planting rates interface, wherein the planting rates interface generates amounts of each of the at least one product and transmits the amounts to the shopping list interface configured to generate a list of the at least one products.

15. The system of claim 14, further comprising a kiosk provided within a store location, wherein the kiosk comprises a printer to print a hard-copy document including the shopping list.

16. The system of claim 15, wherein the kiosk comprises a scanner to scan at least one of the following: a barcode, and a QR code each provided on the users smart device.

17. The system of claim 16, further comprising a provider list interface to permit the provider to input store information including a location corresponding to the provider, wherein the provider list interface is in operable communication with an inventory management system to provide inventory and prices for each of the plurality of products.

18. The system of claim 17, further comprising a project interface in operable communication with the project database, wherein the project interface permits the provider to input a plurality of project steps.

19. The system of claim 18, wherein the project interface generates the planting guide comprising the plurality of project steps to complete the project, and wherein the planting guide is provided on the display of the computing device.

20. A system for recommending products and providing instructions for projects, the system comprising:
a product database to store a plurality of product information;
a project database to store a plurality of project information, project information including a plurality of steps and a plurality of products to complete the project;
a user interface module to display the plurality of steps and the plurality of products on a display of a computing device;
a recommendation engine to recommend at least one of the plurality of products and an amount for each of the plurality of products to complete at least one of the plurality of projects, wherein the recommendation engine is in operable communication with the product database and the project database to recommend the at least one product and the at least one project to the user based on an inventory of a store; and
a planting guide builder interface configured to permit the provider to select the at least one product and the at least one project to complete a plurality of steps associated with planting the at least one product to generate a planting guide, wherein the planting guide is transmitted to a user device;
a user database to store user information comprising user purchases, user projects, and user preferences, wherein the recommendation engine is in operable communication with the user database to recommend the at least one product or the at least one project based on the user purchases, the user projects, and the user preferences.
